(19) United States
(12) Patent Application Publication
(10) Pub. No.: US 2006/0262073 A1
(43) Pub. Date: Nov. 23, 2006

(54) Liquid crystal display apparatus and method of driving the same

(75) Inventors: Hiroyuki Sekine, Tokyo (JP); Tetsushi Satou, Tokyo (JP); Kazunori Masumura, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/437,708

(22) Filed: May 22, 2006

(30) Foreign Application Priority Data
May 23, 2005 (JP) 2005-149755

(51) Int. Cl. G09G 3/36

(52) U.S. Cl. 345/100

(57) ABSTRACT

A data line drive circuit for driving pixels via data lines in a liquid crystal display apparatus includes digital-to-analog converter circuits operable to output drive signals from input digital video signals into the data lines. Input-output characteristics of the digital-to-analog converter circuits are dynamically varied during a period of time during which a screenful of video signals are written into the pixels in the liquid crystal display apparatus.

This application claims priority to prior Japanese patent application JP 2005-149755, the disclosure of which is incorporated herein by reference.

### BACKGROUND OF THE INVENTION

1. Field of the Invention

The present invention relates to a liquid crystal display apparatus and a method of driving a liquid crystal display apparatus.

2. Description of the Related Art

Three-panel liquid crystal projectors are widely used mainly for the purpose of presentation because three-panel liquid crystal projectors can project images with high luminance and high definition. Such a three-panel liquid crystal projector has three liquid crystal display devices corresponding to the three primary colors (red, green, and blue) of light and projects a synthetic image from the three liquid crystal display devices. FIG. 1 shows an example of a conventional three-panel liquid crystal projector. As shown in FIG. 1, the three-panel liquid crystal projector includes a lamp 101 as a light source, color separation mirrors 102a and 102b, liquid crystal display devices 103a, 103b, and 103c for red, green, and blue, respectively, a synthetic prism 104, and a projection lens 105. White light is emitted from the lamp 101 and separated into components of red, green, and blue by the color separation mirrors 102a and 102b. The components are introduced into the liquid crystal display devices 103a, 103b, and 103c for red, green, and blue, respectively. Each of the liquid crystal display devices displays an image of each color. The synthetic prism 104 produces a synthetic image of full color from images of the respective liquid crystal display devices. The synthetic image is projected through the projection lens 105 onto a screen. The three-panel liquid crystal projector also includes an optical device for equalizing light from the light source, a polarization converter, and a polarization plate, which are not shown in FIG. 1.

FIG. 2 shows an arrangement of a liquid crystal display device used in such a three-panel liquid crystal projector. The liquid crystal display device shown in FIG. 2 has data lines D1 to Dn extending in a vertical direction, gate lines G1 to Gm extending in a horizontal direction, pixels P located at intersections of the data lines and the gate lines, a data driver circuit 111 operable to drive the data lines D1 to Dn, and a gate driver circuit 112 operable to drive the gate lines G1 to Gm. FIG. 3 shows an equivalent circuit of the pixel P. As shown in FIG. 3, each pixel includes a pixel thin film transistor TFT, a storage capacitance Cs, and a pixel capacitance Cic. Generally, this type of liquid crystal display device is formed by a P—Si (polysilicon) thin film transistor (TFT) process. P—Si TFT has a current drive capability higher than a-Si (amorphous silicon) TFT. Further, in addition to pixel thin film transistors TFT, portions of the gate driver circuit 112 and the data driver circuit 111 can be formed of P—Si TFT. Accordingly, it is possible to reduce the size of the liquid crystal display device. Compactness of a liquid crystal display device is needed to reduce cost of a projector apparatus. In conventional liquid crystal display devices, a width across corners of a display screen is not more than 1 inch.

Such a data driver circuit in the liquid crystal display device employs the following two methods. In a first method, analog video signals are supplied from the exterior of a system and sequentially sampled by analog switches provided in a liquid crystal display device. This first method is most frequently employed under the present circumstances. In a second method, analog video signals to be supplied to data lines are generated by a data line drive IC formed on a substrate in a liquid crystal display device and sampled into a plurality of data lines by analog switches.

FIG. 4 shows an arrangement of a liquid crystal display device according to the first method. The liquid crystal display device has a data driver circuit including a scanning circuit 113 and analog switches 114. The liquid crystal display device also has a gate driver circuit 112 including a scanning circuit. FIG. 5 is a timing chart showing an operation of the liquid crystal display device shown in FIG. 4. The scanning circuit 113 in the data driver circuit is controlled by a start signal DST and a clock signal DCLK. The scanning circuit 113 sequentially outputs sampling pulses SP1 to SPn, which are synchronized with the clock signal DCLK, from respective output terminals. The output terminals of the scanning circuit 113 are connected to gates of the analog switches 114. In the example shown in FIG. 4, three analog switches are connected to one output terminal for each sampling pulse. Video signals supplied to video signal lines V1 to V3 are simultaneously written into three data lines via the analog switches. Specifically, video signals are written into each block of data lines that are connected to analog switches controlled by one sampling pulse. Accordingly, video signals are written into each block of three data lines during a period TH, during which the video signals are written into one pixel row in the liquid crystal display device. During the period TH, the gate driver circuit 112 writes a potential that allows a pixel thin film transistor TFT to be in a conducted state into one of the gate lines G1 to Gm. Thus, the video signals can be written into one row of the pixels during the period TH. This operation is performed for all of the gate lines G1 to Gm to display a screenful of video signals.

The aforementioned operation, in which video signals are written into each block of data lines, is referred to as a block division drive. A liquid crystal display device using a block division drive can advantageously reduce the number of electrically connecting portions between an external circuit and the liquid crystal display device. For example, in a case of a predominant liquid crystal display device having a resolution of 1,024 pixels (horizontal)×768 pixels (vertical), video signals are supplied from the exterior of the device through 6 to 24 signal lines. Control signals are supplied into a data driver circuit through about 10 signal lines including a power supply. Further, control signals are supplied into a gate driver circuit through less than 10 signal lines including a power supply. Thus, the liquid crystal display device can be driven with about 30 to 50 signal lines in total, including a connecting terminal to a counter electrode, a signal terminal to a precharge circuit, and the like.

FIG. 6 shows an arrangement of a liquid crystal display device employing the second method. The liquid crystal display device has a data driver circuit including a data line drive circuit IC 116 and switches 117 for connecting outputs of the data line drive circuit IC 116 to a plurality of data lines D1 to Dn. The liquid crystal display device also has a gate driver circuit 112. The data line drive circuit IC 116 is formed by monocrystal silicon connected to a substrate of the liquid crystal display device by chip-on-glass (COG) interconnections. The gate driver circuit 112 shown in FIG. 6 may have the same arrangement as the gate driver circuit 112 in the liquid crystal display device shown in FIG. 4. The arrangement shown in FIG. 6 is often employed in liquid crystal display devices for personal digital assistants. According to recent progress in miniaturization and high accuracy of the data line drive circuit IC, the arrangement shown in FIG. 6 is also applicable to liquid crystal display devices for projectors. In the example shown in FIG. 6, each output terminal of the data line drive circuit IC 116 is connected to three data lines via three analog switches, which are controlled individually by separate sampling pulses SPa1 to SPa3.

Operation of the liquid crystal display device shown in FIG. 6 will be described below with reference to a timing chart shown in FIG. 7. A signal HSYNC represents breaks of horizontal periods TH, during which video signals are written into pixels connected to one gate line in the liquid crystal display device. The output terminals V1 to Vk of the data line drive circuit IC 116 output video signals during the horizontal period TH by three cycles. At that time, sampling pulses SPa1 to SPa3 are time-shared in synchronism with the video signal outputs. Accordingly, three data lines are supplied via the analog switches 117 with video signals to be written with time-sharing. This operation is performed for all output terminals of the data line drive circuit IC 116. Thus, the video signals are written into all data lines during one horizontal period TH by three cycles. At that time, the gate driver circuit 112 outputs a pulse that allows a pixel thin film transistor TFT to be in a conducted state into one of the gate lines G1 to Gm so as to write the video signals, which are supplied into the data lines, into the pixels. This operation is performed for all of the gate lines G1 to Gm to write a screenful of video signals.

As compared to a liquid crystal display device using a block division drive, a liquid crystal display device using the second method has an increased number of electrically connecting portions. In a case of a liquid crystal display device having a resolution of 1,024 pixels (horizontal)×768 pixels (vertical), there are hundreds of electrically connecting portions. However, it is possible to lengthen a sampling period during which the analog switches write video signals. The number of data lines driven by one of the output terminals in the data line drive circuit IC 116 is determined by connection pitches of the data line drive circuit IC 116 and pitches of the pixels. The connection pitches are about 50 μm. When the liquid crystal display device has a display screen with a diagonal of 1 inch, the pitches of the pixels become about 20 μm. Connection can be established if three or more data lines are provided for one of the output terminals in the data line drive circuit IC 116. Assuming that three data lines are driven by one of the output terminals in the data line drive circuit IC 116, it is possible to obtain a sufficient sampling period as long as about 7 μs. Accordingly, even if TFT forming the analog switches 117 has variations in properties, an error in a writing rate can be made extremely small. Thus, it is possible to display uniform images.

Meanwhile, a display device has a gamma, i.e., properties in which an output is nonlinear with respect to an applied voltage. For example, in order to correct the gamma, Japanese laid-open patent publication No. 10-108040, which is hereinafter referred to as Patent Document 1, discloses a gamma correction circuit for driving a liquid crystal element (FIG. 1). FIG. 8 shows such a gamma correction circuit. As shown in FIG. 8, the gamma correction circuit 3 has a resistance string 32′ and a DAC circuit (decoder 33). The resistance string 32′ has a plurality of resistances r1 to r64 connected in series. A voltage (V₀, V₆₄) is applied between opposite ends of the resistance string 32′. The DAC circuit selectively outputs one of a plurality of voltages, which are divided by the resistances r1 to r64, according to digital data. The resistances in the resistance string 32′ are selected so that voltages divided by the resistance string 32′ are equal to voltages after gamma correction of video signals. In such a case, a function of gamma correction can be provided to input-output characteristics of the DAC circuit. In this manner, since the input-output characteristics of the DAC circuit have the function of gamma correction, an additional gamma correction circuit is not required. Accordingly, compactness of the display device can be achieved.

Further, a display device has output characteristics to applied voltages that vary according to positions in a panel. Slight difference of the output characteristics due to positions in the panel may be recognized as color irregularities in a displayed image. For example, in order to solve this drawback, Japanese laid-open patent publication No. 2000-267638, which is hereinafter referred to as Patent Document 2, discloses a method of controlling a gamma according to positions in a panel when gamma correction is performed using a look-up table (FIG. 1). In this method, correction waveform data are stored in a memory so as to correspond to positions in the panel. Based on the correction waveform data, signals to be inputted into a gamma correction circuit are varied according to positions in the panel. Specifically, D/A conversion is performed on the correction waveform data to produce correction waveform signals. The correction waveform signals are inputted into a reference voltage terminal of an A/D conversion circuit. Thus, the linearity of the A/D conversion is varied so as to obtain an effect equivalent to an effect obtained when the gamma correction characteristics are varied.

However, the method of Patent Document 2 requires a gamma correction circuit in addition to a DAC circuit and thus fundamentally increases an area of circuits. The gamma correction circuit of Patent Document 1 can reduce an area of circuits because the DAC circuit also has a gamma correction function. However, the gamma correction circuit of Patent Document 1 cannot change gamma correction characteristics according to positions in the panel.

Further, signals to be inputted into the DAC circuit of Patent Document 1 may be varied according to positions in the panel by using the method of Patent Document 2, which varies signals to be inputted into the gamma correction circuit according to positions in the panel. However, because the DAC circuit of Patent Document 1 has nonlinear outputs, color irregularities cannot be eliminated only by varying input signals.

If the DAC circuit has linear outputs, desired outputs can be obtained by varying input signals according to positions in the panel. However, in order to achieve an output accuracy in a linear DAC circuit as high as that in a nonlinear DAC circuit, the size of the DAC circuit should be large. Thus, cost for IC is increased. For example, a nonlinear DAC circuit is required to have an output accuracy of 8 bits for 8-bit gradation display, whereas a linear DAC circuit is required to have an output accuracy of about 10 bits for 8-bit gradation display. A 10-bit DAC circuit has an area about four times that of an 8-bit DAC circuit. Thus, cost for IC is inevitably increased.

### SUMMARY OF THE INVENTION

It is, therefore, an object of the present invention to provide a data line drive circuit which can vary input-output characteristics without increasing an accuracy of a DAC circuit and eliminate production of luminance irregularities in a screen of a liquid crystal display apparatus. It is another object of the present invention to provide a liquid crystal display apparatus which can display an image having no luminance irregularities in a screen.

In order to attain the above objects, according to the present invention, there are provided nonlinear DAC circuits operable to vary their input-output characteristics into desired characteristics.

Specifically, according to a first aspect of the present invention, a DAC circuit includes a reference voltage generation circuit operable to generate a plurality of desired reference voltages, a plurality of resistances connected in series between the plurality of reference voltages supplied from the reference voltage generation circuit, and a decoder operable to select one of potentials of nodes of the resistances as an analog signal.

Reference voltages generated by the reference voltage generation circuit can be adjusted to set potentials of the nodes of the resistances at desired values. Consequently it is possible to obtain the nonlinear DAC circuit which can change input-output characteristics of the DAC circuit into desired characteristics.

Even if a display device has different gammas from position to position, it is possible to reduce positional luminance irregularities by using a plurality of such nonlinear DAC circuits in a data line drive circuit.

According to a second aspect of the present invention, a data line drive circuit is configured to drive pixels via data lines in a liquid crystal display apparatus. The data line drive circuit has digital-to-analog converter circuits, which are hereinafter referred to as DAC circuits, operable to output drive signals from input digital video signals into the data lines. Input-output characteristics of the DAC circuits are dynamically varied during a period of time during which a screenful of video signals are written into the pixels in the liquid crystal display apparatus.

It is desirable that the input-output characteristics of the digital-to-analog converters are varied at each period during which video signals are written into one pixel row. Further, the input-output characteristics of the digital-to-analog converters may be nonlinear.

According to a third aspect of the present invention, a data line drive circuit is configured to drive pixels via data lines in a liquid crystal display apparatus. The data line drive circuit has a reference voltage generation circuit operable to generate a plurality of reference voltages and a voltage division circuit operable to divide the plurality of reference voltages into division voltages. The number of the division voltages is greater than the number of the reference voltages. The data line drive circuit also has DAC circuits operable to select one of the division voltages generated in the voltage division circuit based on an input digital video signal and to output the one of the division voltages as a drive signal into the data lines. The reference voltages are varied during a vertical period, during which a screenful of video signals are written into the pixels in the liquid crystal display apparatus, to vary input-output characteristics of the DAC circuits.

The reference voltage generation circuit may include a memory operable to store information indicative of a position in a screen of the liquid crystal display apparatus and information indicative of selection of the reference voltages at the position. The reference voltage generation circuit may also include an output circuit operable to read and output the reference voltages at a position corresponding to a scanning signal of the screen from the memory.

Each of the DAC circuits may include a decoder operable to decode the digital video signals and a selector operable to select one of the reference voltages supplied from the voltage division circuit based on an output of the decoder and to output the one of the reference voltages as an analog signal.

The data line drive circuit may be a semiconductor circuit connected on a transparent substrate forming the liquid crystal display apparatus.

According to a fourth aspect of the present invention, a liquid crystal display apparatus has data lines, pixels into which video signals are written via the data lines, and the data line drive circuit for driving the pixels via the data lines. The video signals are written into all of the pixels so as to have the same polarity with respect to a potential of a counter electrode during a period during which a screenful of video signals are displayed in the liquid crystal display apparatus.

It is desirable that the liquid crystal display apparatus is configured to display a screenful of video signals at a frequency of at least 120 Hz.

The liquid crystal display apparatus may include a first substrate on which the pixels are formed and a second substrate formed so as to face the first substrate. In this case, it is desirable that no color filters are provided on the first substrate or the second substrate, and that light having different wavelength ranges is applied in synchronism with a cycle in which a screenful of video signals are written.

According to a fifth aspect of the present invention, a projector apparatus includes the aforementioned liquid crystal display device.

According to a sixth aspect of the present invention, a terminal apparatus includes the aforementioned liquid crystal display device.

According to a seventh aspect of the present invention, pixels are driven via data lines in a liquid crystal display apparatus to display an image in the liquid crystal display apparatus. Drive signals are outputted from input digital video signals into the data lines by digital-to-analog conversion. Input-output characteristics of the digital-to-analog conversion are dynamically varied during a period of time during which a screenful of video signals are written into the pixels in the liquid crystal display apparatus.

In this case, the input-output characteristics of the digital-to-analog conversion may be varied at each period during which video signals are written into one pixel row. The input-output characteristics of the digital-to-analog conversion may be nonlinear. It is desirable that a screenful of video signals are displayed at a frequency of at least 120 Hz. It is also desirable that the liquid crystal display apparatus includes no color filters on a first substrate on which the pixels are formed or a second substrate formed so as to face the first substrate, and that light having different wavelength ranges is applied in synchronism with a cycle in which a screenful of video signals are written.

According to the data line drive circuit of the present invention, reference voltages supplied to the voltage division circuit, which supplies voltages to the DAC circuits, are varied depending upon pixels into which the signals are to be supplied in the liquid crystal display apparatus. Thus, V-T conversion can be performed so as to accord with variations of V-T characteristics (transmittance characteristics to applied voltage in the pixels) in a screen.

According to the present invention, reference voltages to determine the V-T characteristics are dynamically varied so as to vary the V-T characteristics depending upon positions of the pixels into which video signals are to be written in the liquid crystal display apparatus. Therefore, it is possible to reduce the luminance irregularities in the screen of the liquid crystal display apparatus. The luminance irregularities in the screen of the liquid crystal display apparatus are caused because the same V-T conversion is performed on all video signals to be written into pixels in the liquid crystal display apparatus although the V-T characteristics of the liquid crystal display apparatus have positional dependency. Accordingly, by varying V-T characteristics for video signals depending upon pixels into which the video signals are to be written, it becomes possible to reduce luminance irregularities.

Further, according to the present invention, it is possible to reduce the size of circuits. A conventional data line drive circuit capable of varying V-T characteristics employs DACs having linear input-output characteristics and performs arithmetic V-T conversion on digital signals. In this case, the conventional data line drive circuit should use DAC circuits having an accuracy of at least 10 bits in order to obtain outputs having a high accuracy corresponding to nonlinear V-T characteristics of a liquid crystal display apparatus. In contrast thereto, the data line drive circuit according to the present invention employs DAC circuits having nonlinear input-output characteristics and dynamically varies reference voltages of the voltage division circuit so as to vary input-output characteristics of the DAC circuits. Thus, the data line drive circuit according to the present invention can cope with variations of the V-T characteristics in the liquid crystal display apparatus. With this arrangement, an accuracy of about 8 bits is sufficient for the DAC circuits, and thus it is possible to reduce the size of circuits as compared to the conventional data line drive circuit.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a schematic view showing a projector apparatus using liquid crystal display devices;

FIG. 2 is a schematic view showing a conventional liquid crystal display device;

FIG. 3 is a circuit diagram showing an equivalent circuit of a pixel in the conventional liquid crystal display device shown in FIG. 2;

FIG. 4 is a schematic view showing an arrangement of another conventional liquid crystal display device;

FIG. 5 is a timing chart showing an operation of the liquid crystal display device shown in FIG. 4;

FIG. 6 is a schematic view showing an arrangement of still another conventional liquid crystal display device;

FIG. 7 is a timing chart showing an operation of the liquid crystal display device shown in FIG. 6;

FIG. 8 is a circuit diagram showing a conventional gamma correction circuit for driving a liquid crystal element;

FIG. 9 is a schematic view showing an arrangement of a data line drive circuit in a liquid crystal display apparatus according to an embodiment of the present invention;

FIG. 10 is a graph showing an example of V-T characteristics of the liquid crystal display apparatus;

FIG. 11 is a graph showing input-output characteristics of a DAC circuit in the data line drive circuit shown in FIG. 9;

FIG. 12 is a timing chart showing an operation of the data line drive circuit shown in FIG. 9;

FIG. 13 is a graph showing variations of V-T correction characteristics;

FIG. 14 is a graph explanatory of setting reference voltages in a data line drive circuit according to the present invention;

FIG. 15 is a schematic view showing a first example of the data line drive circuit according to the present invention;

FIG. 16 is a schematic view showing an arrangement of a liquid crystal display apparatus using the data line drive circuit shown in FIG. 15;

FIG. 17 is a schematic view showing an arrangement of a line memory in the data line drive circuit shown in FIG. 15;

FIG. 18 is a schematic view showing an arrangement of a decoder in the data line drive circuit shown in FIG. 15;

FIG. 19 is a schematic view showing an arrangement of a selector in the data line drive circuit shown in FIG. 15;

FIG. 20 is a schematic view showing an arrangement of a buffer in the data line drive circuit shown in FIG. 15;

FIG. 21 is a schematic view showing an arrangement of a voltage division circuit in the data line drive circuit shown in FIG. 15;

FIG. 22 is a schematic view showing another arrangement of the voltage division circuit in the data line drive circuit shown in FIG. 15;

FIG. 23 is a schematic view showing an arrangement of a reference voltage generation circuit in the data line drive circuit shown in FIG. 15;

FIG. 24 is a schematic view showing an arrangement of a gate driver circuit in a liquid crystal display apparatus shown in FIG. 16;

FIG. 25 is a timing chart showing an operation of a data line drive circuit according to the present invention;

FIG. 26 is a timing chart showing an operation of a data line drive circuit according to the present invention;

FIG. 27 is a schematic view showing an arrangement of an external drive circuit and a liquid crystal display apparatus using a data line drive circuit according to the present invention;

FIG. 28 is a timing chart showing an operation of the external drive circuit shown in FIG. 27;

FIG. 29 is a graph showing positional dependency of contrast in a liquid crystal display apparatus according to the present invention;

FIG. 30 is a graph showing positional dependency of V-T characteristics in a liquid crystal display apparatus according to the present invention; and

FIG. 31 is a timing chart showing an operation of a liquid crystal display apparatus using a data line drive circuit according to the present invention.

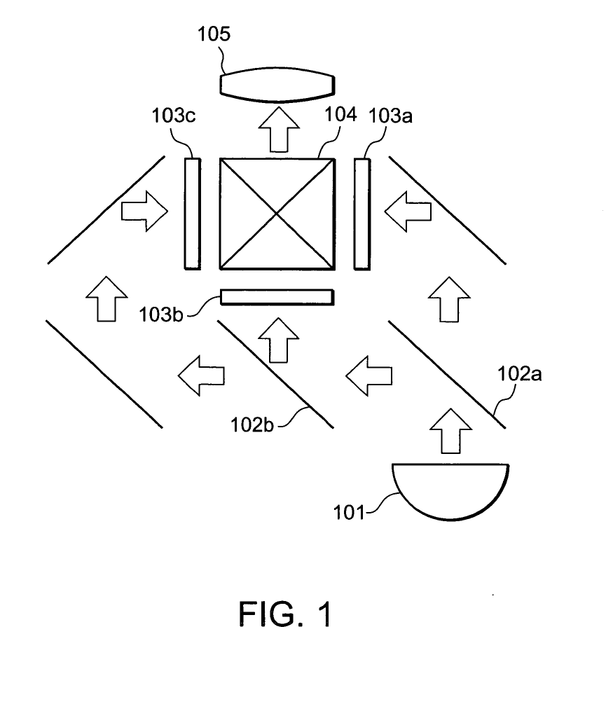

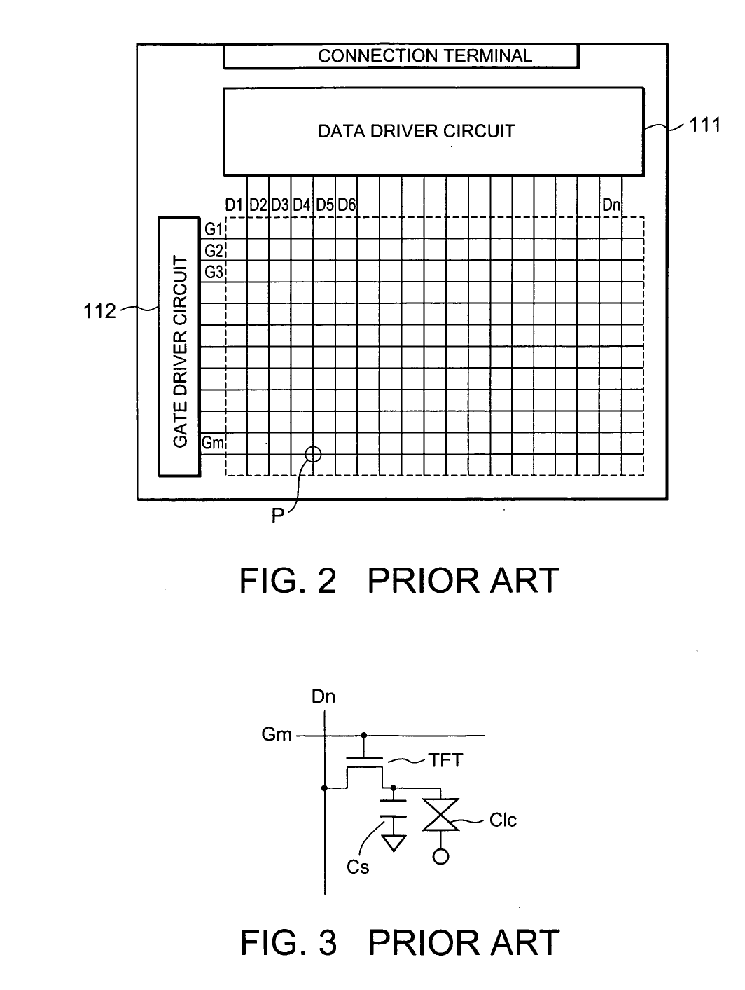

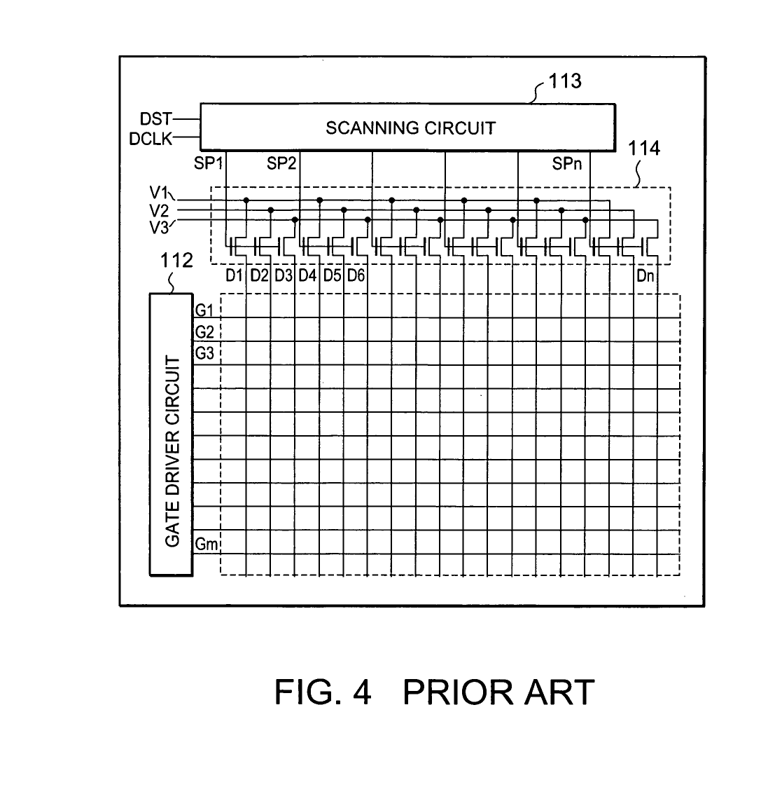

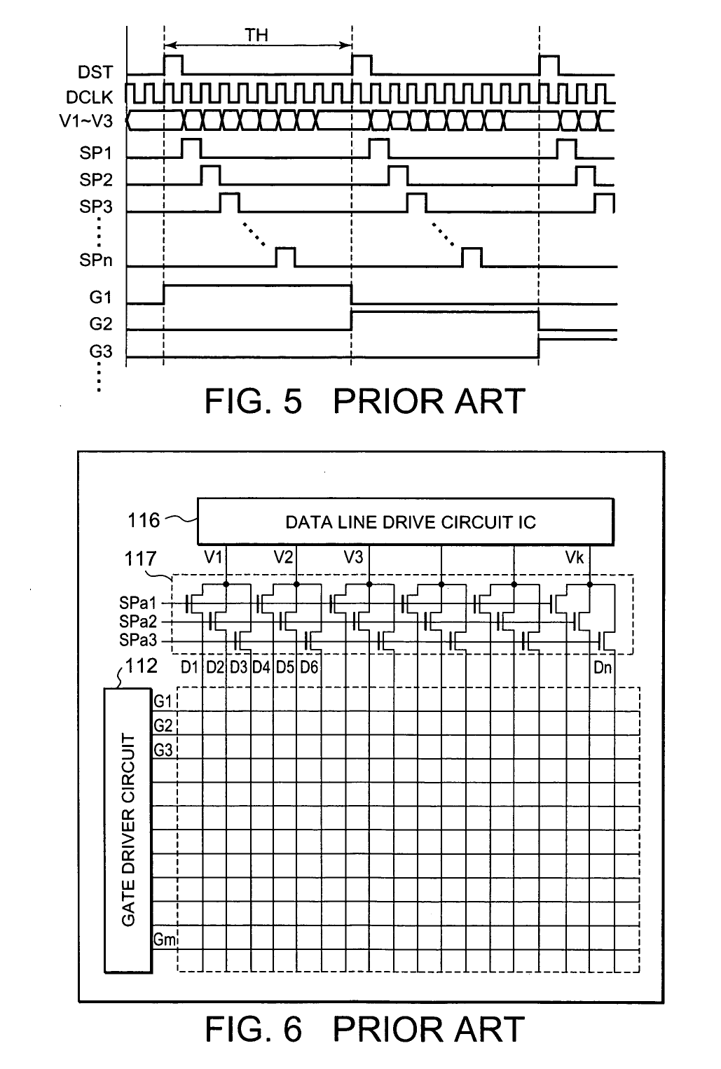

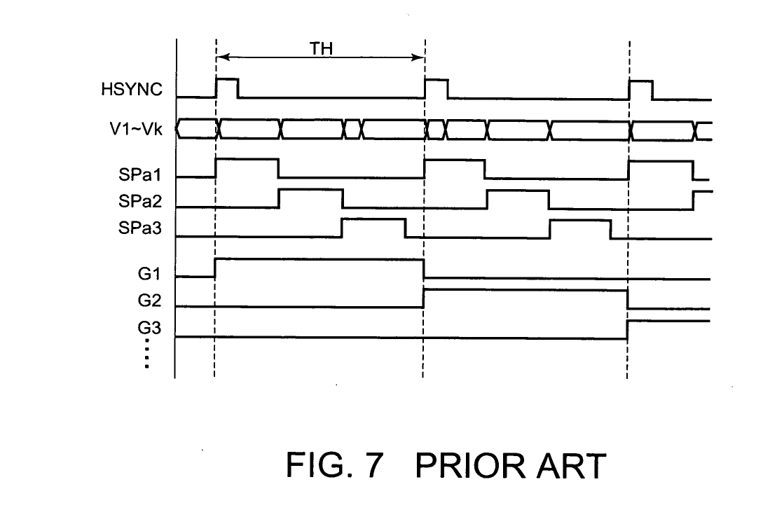

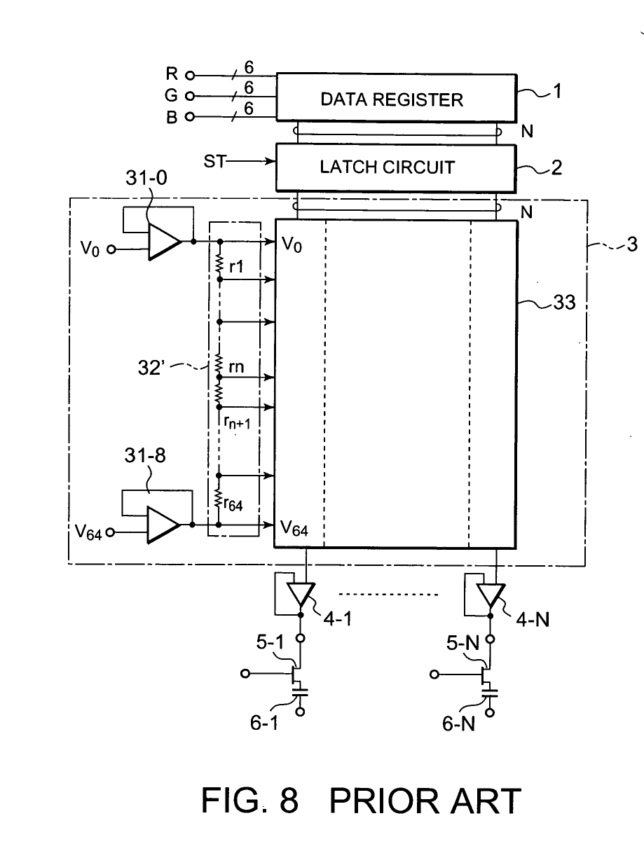

### DETAILED DESCRIPTION OF THE PREFERRED EMBODIMENTS

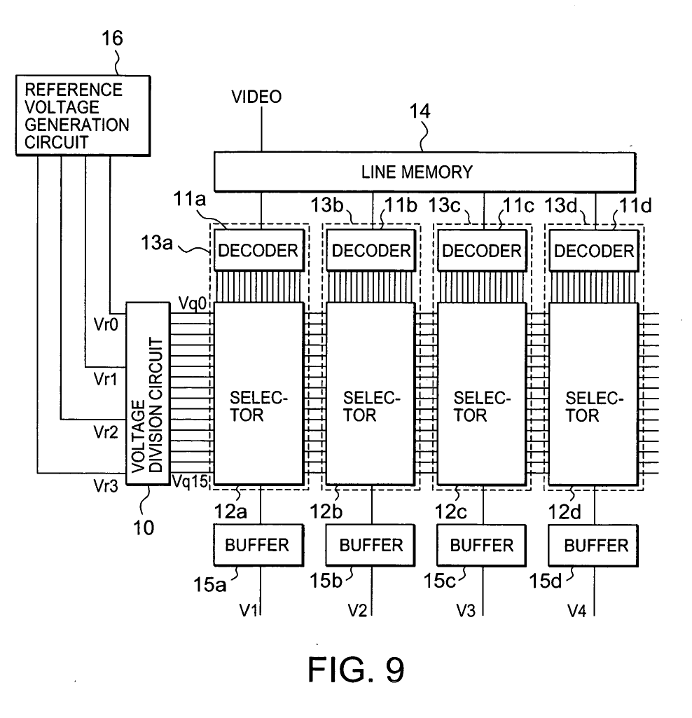

A liquid crystal display apparatus according to embodiments of the present invention will be described below with reference to FIGS. 9 through 31. Like or corresponding parts are denoted by like or corresponding reference numerals throughout drawings, and will not be described below repetitively.

FIG. 9 shows an arrangement of a data line drive circuit in a liquid crystal display apparatus according to an embodiment of the present invention. As shown in FIG. 9, the data line drive circuit in the present embodiment includes a voltage division circuit 10 operable to generate a plurality of voltages from reference voltages, DACs 13a, 13b, 13c, and 13d, a line memory 14 operable to sample and hold video signals supplied from the exterior of the data line drive circuit and to supply the video signals to the DACs 13a, 13b, 13c, and 13d, buffers 15a, 15b, 15c, and 15d operable to buffer outputs of the DACs 13a, 13b, 13c, and 13d, and a reference voltage generation circuit 16 operable to supply reference voltages to the voltage division circuit 10. The DACs 13a, 13b, 13c, and 13d have decoders 11a, 11b, 11c, and 11d and selectors 12a, 12b, 12c, and 12d, respectively.

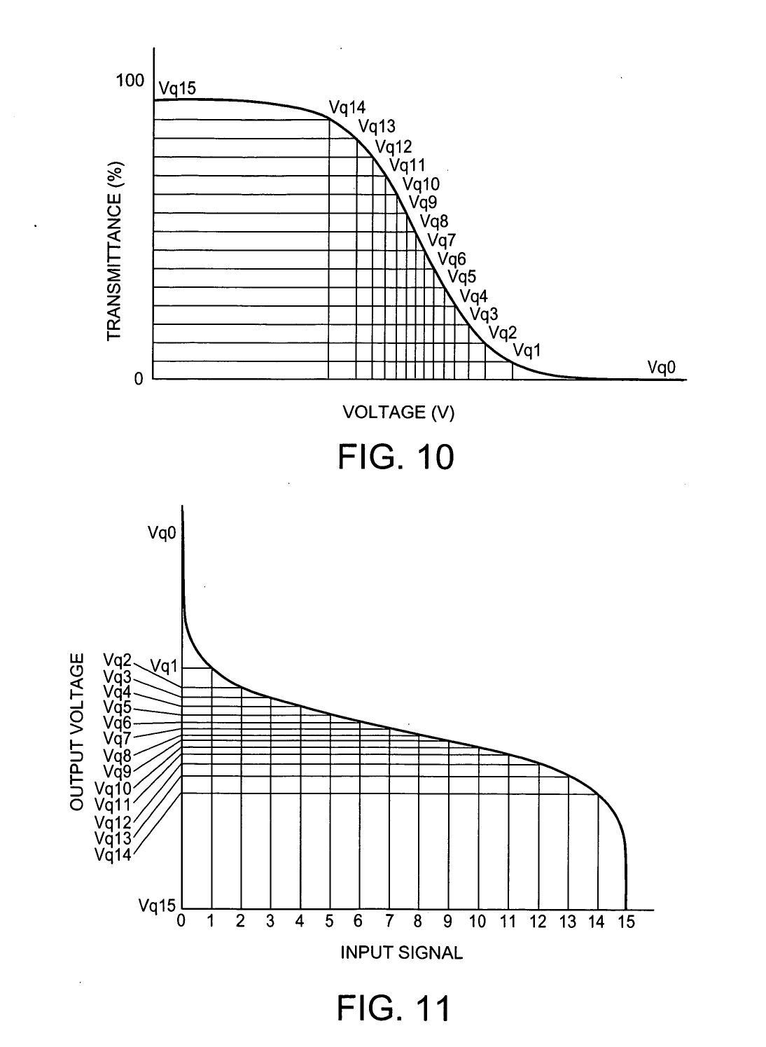

The number of the DACs 13a, 13b, 13c, and 13d and the number of the buffer circuits 15a, 15b, 15c, and 15d are not less than the number of outputs of the data line drive circuit. The voltage division circuit 10 has a function to divide supplied reference voltages. In the example shown in FIG. 9, four reference voltages Vr0 to Vr3 are divided into 16 types of voltages Vq0 to Vq15 to be outputted. When V-T characteristics (transmittance characteristics to applied voltage) at a certain position in a liquid crystal display apparatus are represented as shown in FIG. 10, voltages Vq0 to Vq15 are set such that the transmittance of 0 to 100% is equally divided into 16 parts by the voltages Vq0 to Vq15. Then, the DACs obtain input-output characteristics as shown in FIG. 11. In this example, when the digital input signal is zero, black is outputted. The characteristics shown in FIG. 11 represent an inverse function of the V-T characteristics shown in FIG. 10 and serve as characteristics for V-T correction.

The line memory 14 is supplied with a digitized video signal VIDEO from the exterior of the data line drive circuit. The line memory 14 holds signals corresponding to one row of pixels in the liquid crystal display apparatus. The held video signals are transferred to the decoders 11a, 11b, 11 c, and 11d. Each of the decoders 11a, 11b, 11c, and 11d outputs 16 decode signals corresponding to the inputted digital signal. Each of the selectors 12a, 12b, 12c, and 12d selects one of 16 voltage lines outputted from the voltage division circuit 10 so as to correspond to the 16 decode signals and outputs it into the buffers 15a, 15b, 15c, and 15d. During one horizontal period, the video signals held in the line memory 14 are outputted simultaneously or separately from the buffers 15a, 15b, 15c, and 15d. In this manner, it is possible to write signals corresponding to one pixel row in the liquid crystal display apparatus.

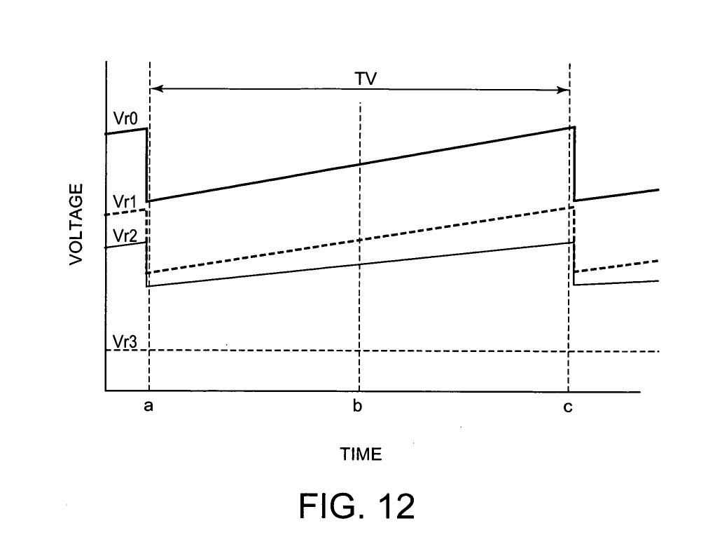

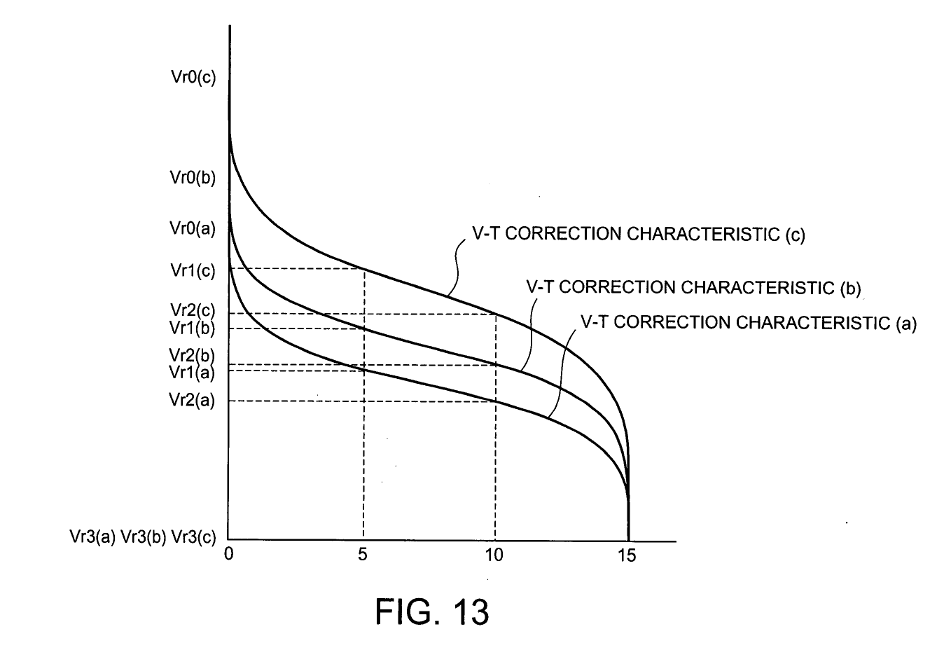

FIG. 12 shows variations of reference voltages during one vertical period TV, during which a screenful of video signals are written in the liquid crystal display apparatus. In the illustrated example, the reference voltages are changed at the beginning and end of the vertical period TV in synchronism with timing at which horizontal periods are changed. When the reference voltages are thus changed, the outputs of the voltage division circuit 10 are also varied. Thus, the DACs obtain input-output characteristics as shown in FIG. 13. In FIG. 13, V-T correction characteristics (a) represent input-output characteristics of the DACs which are produced from reference voltages at a time point (a) in FIG. 12. Similarly, V-T correction characteristics (b) and (c) represent input-output characteristics of the DACs which are produced from reference voltages at time points (b) and (c) in FIG. 12, respectively. Thus, by varying reference voltages, input-output characteristics of the DACs, which are characteristics for V-T correction, can dynamically be varied during the vertical period.

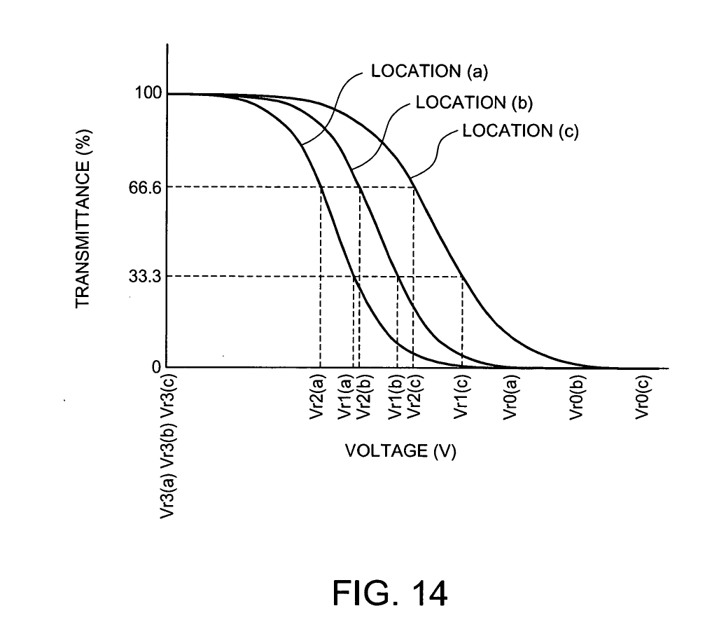

The reference voltages can be set in the following manner. FIG. 14 shows V-T characteristics of the liquid crystal display apparatus at three positions. The characteristics at a location (a) are V-T characteristics near a pixel row into which signals are written at the time point (a) in FIG. 12. The characteristics at locations (b) and (c) are V-T characteristics near pixel rows into which signals are written at the time points (b) and (c), respectively. This data line drive circuit requires four voltages as reference voltages. These reference voltages are voltages at which the transmittance of the liquid crystal display apparatus is near 0%, 33%, 66%, and 100%, respectively. Thus, voltages corresponding to transmittances of 0%, 33%, 66%, and 100% on the three V-T characteristic lines shown in FIG. 14 are respectively calculated and used as reference voltages. For example, voltages at the location (a) that correspond to transmittances of 0%, 33%, 66%, and 100% are represented by Vr0(a), Vr1(a), Vr2(a), and Vr3(a). At that time, the V-T correction characteristics shown in FIG. 13 become characteristics that linearly correct the V-T characteristics shown in FIG. 14. It is desirable to determine a ratio of division in the voltage division circuit 10 based on the V-T characteristics at the location (a) because the transmittance often drastically varies with respect to the voltage on the V-T characteristic lines at the location (a).

In the above examples, the liquid crystal display apparatus has a 16-step gradation for the sake of brevity. However, the present invention is not limited to a 16-step gradation in theory. Assuming that nature images are to be displayed, it is desirable that the liquid crystal display apparatus has a 256-step gradation or a higher level of gradation. Further, time variations of the reference voltages are shown as being linear in the graph of FIG. 12. However, the characteristics of the panel determine whether or not the time variations of the reference voltages are linear. No theoretical problem arises even if time variations of the reference voltages are curved.

The data line drive circuit according to the present invention can remarkably reduce luminance irregularities even if the V-T characteristics depend on positions in the liquid crystal display apparatus. In the data line drive circuit according to the present invention, since reference voltages supplied to the voltage division circuit, which generates voltages to be supplied to the DACs, can dynamically be varied during the vertical period, characteristics for V-T correction can be varied so as to perform V-T correction which accords with different V-T characteristics from position to position.

Further, the data line drive circuit according to the present invention can reduce the size of circuits. In a conventional circuit to dynamically vary V-T characteristics, input-output characteristics of DACs are linear (in the form of a straight line), and video signals are digitally corrected. Accordingly, in order to eliminate effects due to rounding errors, the DACs should have an accuracy of at least 10 bits. In contrast to the conventional circuit, since the circuit according to the present invention employs nonlinear DACs, it is possible to achieve a gradation control level equal to or higher than that in a case of conventional 10-bit DACs even if DACs have an accuracy as low as 8 bits. As a result, it is possible to reduce the size of circuits.

### EXAMPLE 1

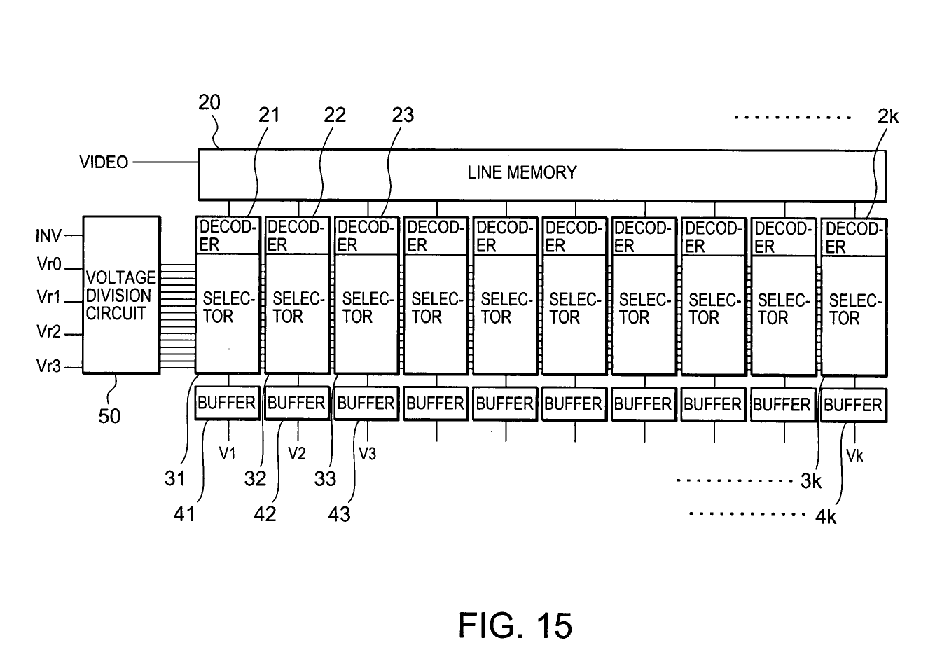

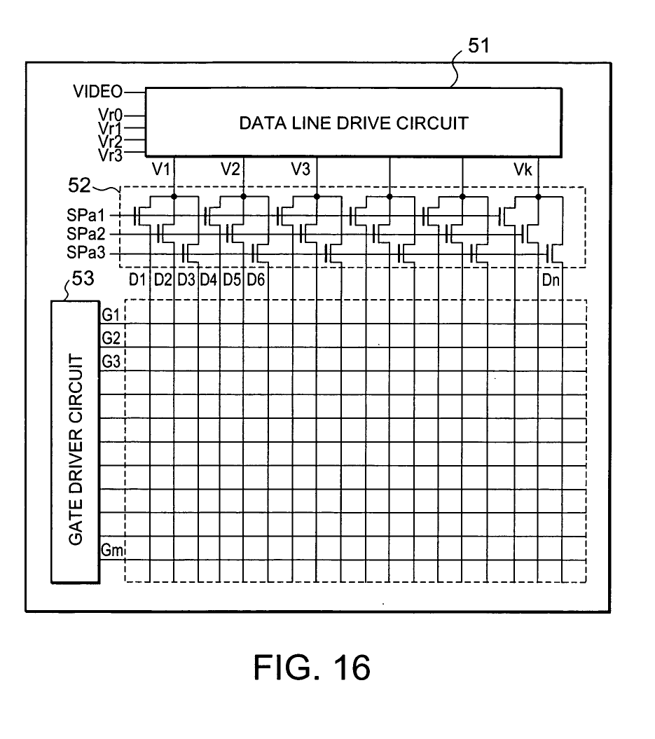

FIG. 15 shows a first example of the data line drive circuit according to the present invention. FIG. 16 shows a liquid crystal display apparatus to be driven by the data line drive circuit shown in FIG. 15. The liquid crystal display apparatus shown in FIG. 16 basically has the same arrangement as the liquid crystal display apparatus shown in FIG. 6. Specifically, the data line drive circuit IC 116, the switches 117, and the gate driver circuit 112 shown in FIG. 6 correspond to a data line drive circuit 51, switches 52, and a gate driver circuit 53 shown in FIG. 16, respectively. In the illustrated example, output terminals of the data line drive circuit 51 drive three data line in the liquid crystal display apparatus with time-sharing.

Circuit components shown in FIG. 15 will be described. As shown in FIG. 15, the data line drive circuit includes a line memory 20, DACs having decoders 21 to 2k and selectors 31 to 3k, buffers 41 to 4k, and a voltage division circuit 50.

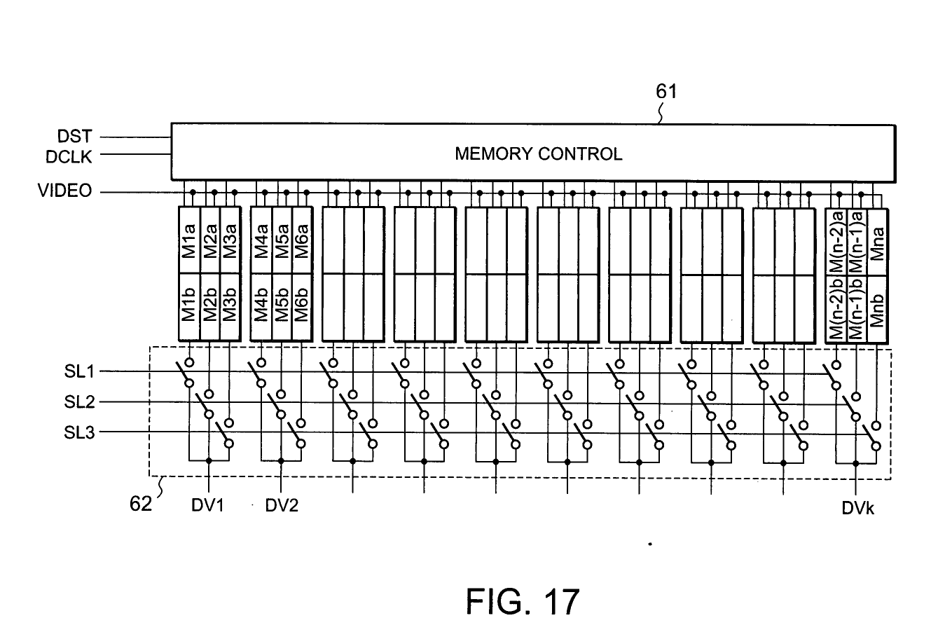

FIG. 17 shows an arrangement of the line memory 20. The line memory 20 is required to have functions to hold video signals of one pixel row in the liquid crystal display apparatus and to sample data of a next pixel row. In order to achieve those functions, the circuit shown in FIG. 17 employs two lines of memories capable of holding video signals for one pixel row. Specifically, the circuit has memories M1a to Mna for holding video signals for one pixel row and memories M1b to Mnb for holding video signals for one pixel row. These memories are controlled by a memory control circuit 61 so as to sequentially write digitalized video signals VIDEO, which are supplied in synchronism with a clock signal DCLK, into the memories M1a to Mna. The video signals written into the memories M1a to Mna are transferred all at once to the memories M1b to Mnb at the end of a horizontal period, which is defined by a control signal DST. A switch 62, which is individually controlled by three control signals SL1, SL2, and SL3, selects one of three memories abutting each other. Thus, the switches 62 output the video signals, which are transferred into the memories M1b to Mnb, as input signals DV1 to DVk into the decoders 21 to 2k.

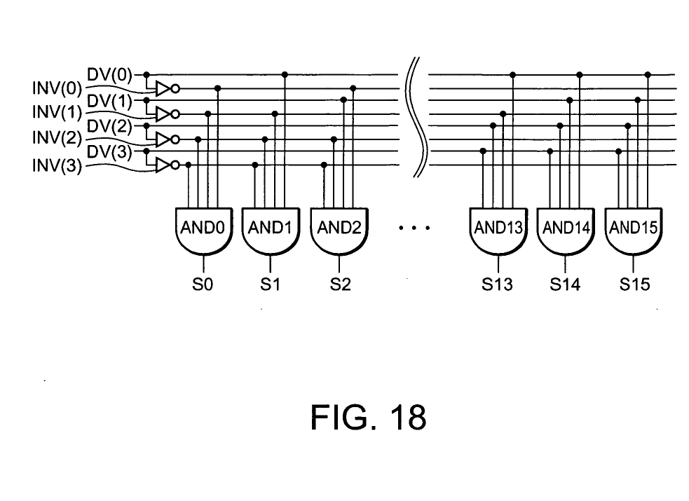

FIG. 18 shows an example of one of the decoders 21 to 2k. The decoders have functions to supply a potential to one of control lines S0 to S15, which control switches in the selectors 31 to 3k, in response to input digital signals DV(0) to DV(3) such that the selector switch is in a conducted state. In the example shown in FIG. 18, the decoder is formed by invertors INV1 to INV3 and AND circuits AND0 to AND15. As a matter of course, components of the decoder have no influence on the essence of the present invention as long as inputs and outputs logically accord with each other. Further, in the illustrated example, 4-bit digital signals DV(0) to DV(3) are decoded to produce 16 outputs of the control lines S0 to S15. The numbers of bits and outputs are determined by the accuracy of DACs. In a case of 8-bit accuracy, the decoder is configured so that 256 outputs are produced from 8-bit digital signals.

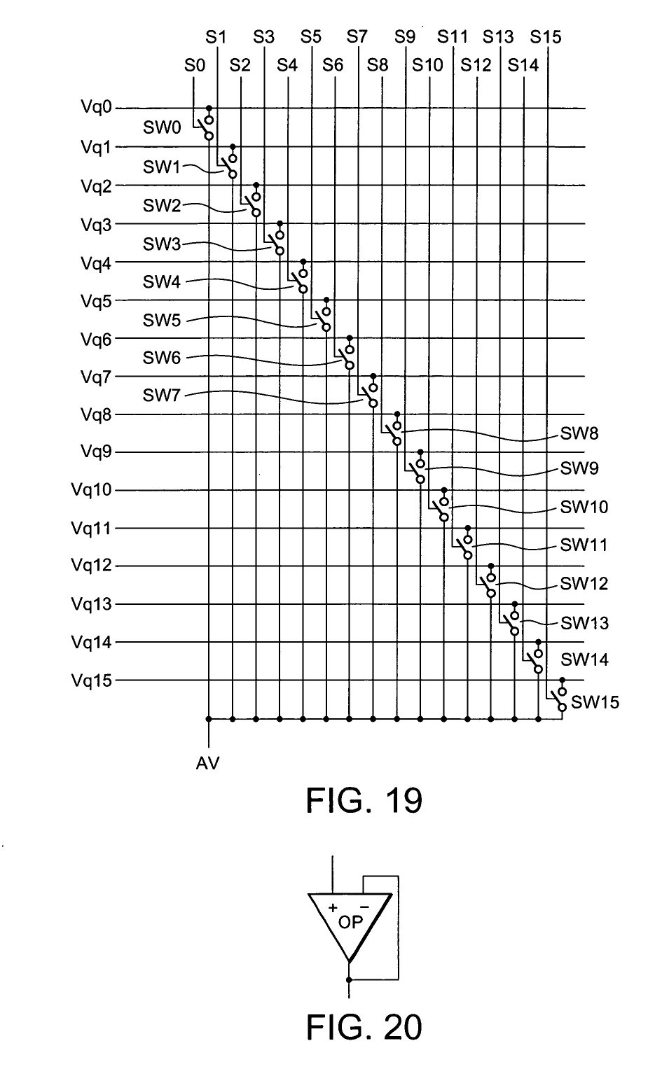

FIG. 19 shows an example of one of the selectors 31 to 3k. The selector is required to have functions to select one of the 16 voltage lines Vq0 to Vq15 inputted from the voltage division circuit 50 in response to the 16 control signals S0 to S15 inputted from the decoder and to output it to a signal line AV. In the example shown in FIG. 19, the voltage lines Vq0 to Vq15 are simply selected by one of 16 switches SW0 to SW15, which are driven by the 16 control signals S0 to S15, respectively. The decoders 21 to 2k and the selectors 31 to 3k are required to select and output one of the plural voltage lines outputted from the voltage division circuit 50 in response to digital video signals inputted from the line memory 20. Other alternates may be used instead of the illustrated example. In the present invention, arrangements of the decoders and the selectors are not important, and the decoders and the selectors can have any arrangement as long as they can have the aforementioned functions.

FIG. 20 shows an example of one of the buffers 41 to 4k. The buffers are required to have functions to write output voltages from DACs, which include the decoders 21 to 2k and the selectors 31 to 3k, into data lines of the liquid crystal display apparatus, which is a capacitive load, during a required period of time. In the example shown in FIG. 20, the buffer includes a voltage follower circuit using an operational amplifier OP. As a matter of course, the buffers may have other arrangements as long as they can have the aforementioned functions.

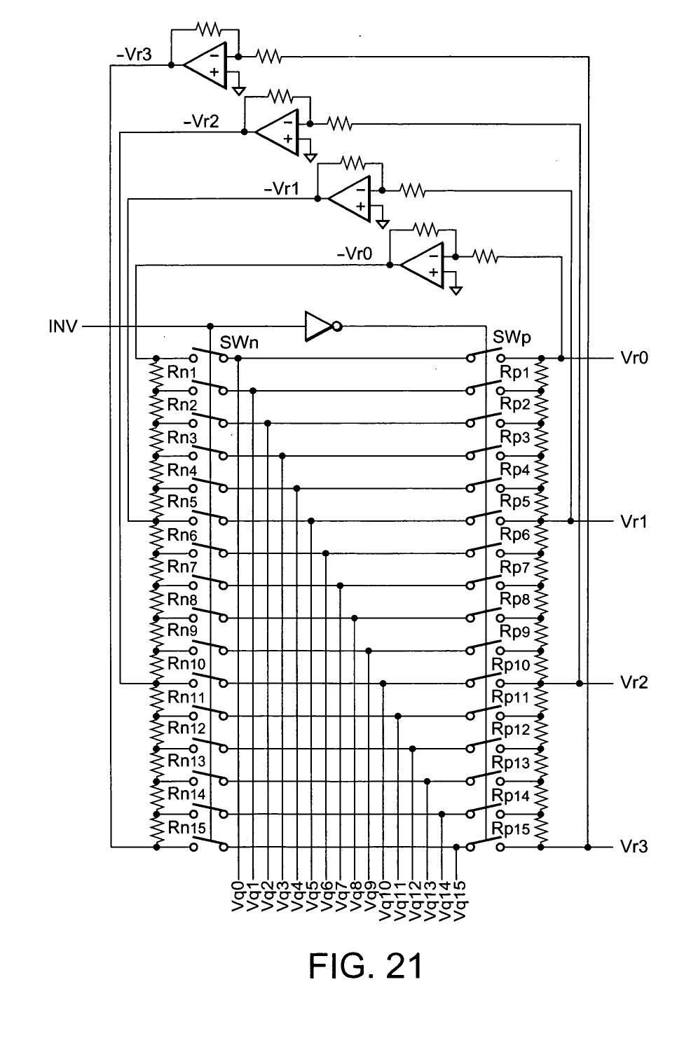

FIG. 21 shows an example of the voltage division circuit 50. The voltage division circuit has functions to divide a plurality of supplied reference voltages and output the corresponding number of voltages to the output accuracy of the DACs. In some cases, the voltage division circuit may be required to have additional functions to reverse polarities of voltages for AC driving of liquid crystals. In the AC driving, polarities of pixel electrodes are alternately changed with respect to potentials of counter electrodes. In the illustrated example, the voltage division circuit 50 includes a function to reverse polarities of voltages. The voltage division circuit 50 divides four reference voltages Vr0 to Vr3 by resistances Rp1 to Rp15 to produce 16 voltages. Further, the voltage division circuit 50 reverses polarities of the reference voltages Vr0 to Vr3, divides four reference voltages −Vr0 to −Vr3 having different polarities by resistances Rn1 to Rn15 to produce 16 voltages of a negative polarity. Switches SWp and switches SWn are opened and closed by a control signal INV to determine the polarity of output voltages. The function to reverse polarities of voltages may be achieved by the aforementioned buffer circuit. In such a case, the voltage division circuit may not have a function to reverse polarities of voltages. Values of the resistances for dividing the reference voltages are determined from V-T characteristics of the liquid crystal display apparatus as described above.

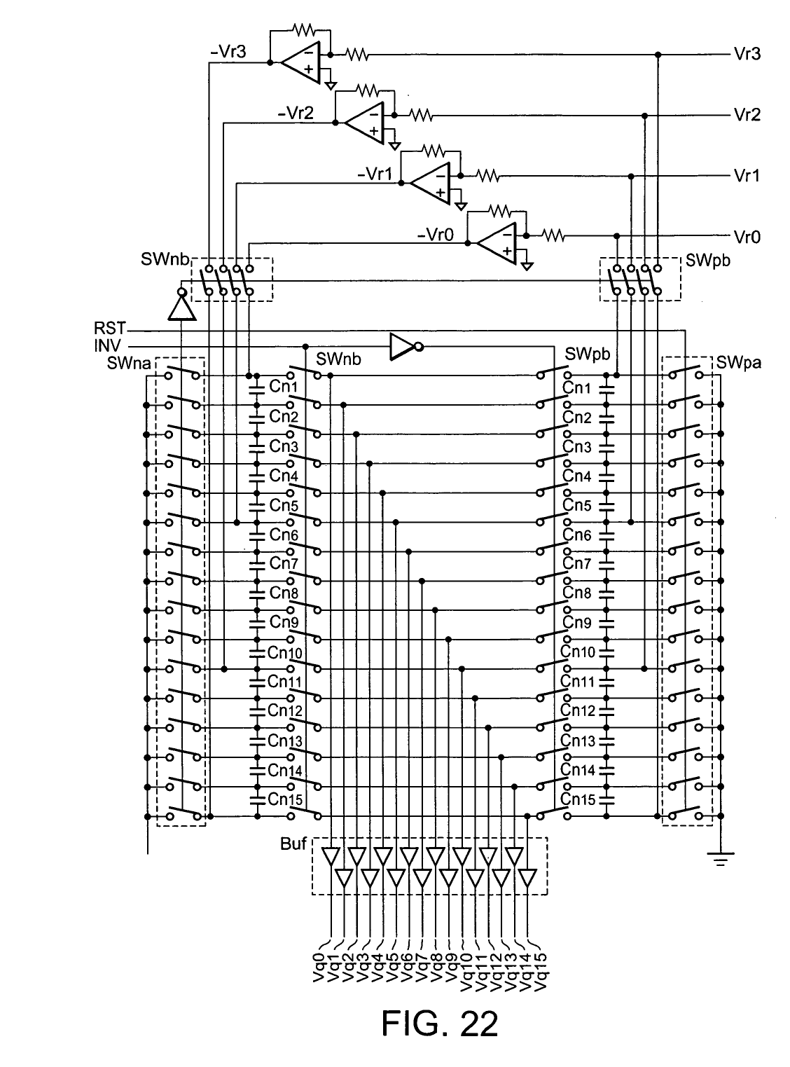

FIG. 22 shows another example of the voltage division circuit 50. The voltage division circuit shown in FIG. 22 differs from the circuit shown in FIG. 21 in that capacitances Cn1 to Cn15 and Cp1 to Cp15 are used for dividing reference voltages, instead of the resistances Rn1 to Rn15 and Rp1 to Rp15 shown in FIG. 21. In the case of the circuit shown in FIG. 21, values of the resistances should be high in order to reduce electric power consumption. However, high-resistance metal cannot be used in some circuit formation processes. In such a case, the length of metal wires of the resistances is increased to provide high resistances, but an area required for the resistances is problematically increased. Since no resistances are used in the circuit shown in FIG. 22, the circuit can divide reference voltages with a small area. Divided voltages should be supplied to the DACs through a buffer circuit Buf. when the reference voltages are varied, it may be necessary to form a short circuit between ends of each capacitance so as to reset electric charge. If a capacitance to be used for division of voltages holds unnecessary electric charge, the circuit cannot divide voltages correctly. The portion Buf shown in FIG. 22 represents a buffer circuit for buffering the divided voltages. In FIG. 22, switches SWna, SWnb, SWpa, and SWpb are used to reset the capacitances. A reset signal RST makes the switches SWna and SWpa in a conducted state and the switches SWnb and SWpb in an open state to reset the capacitances.

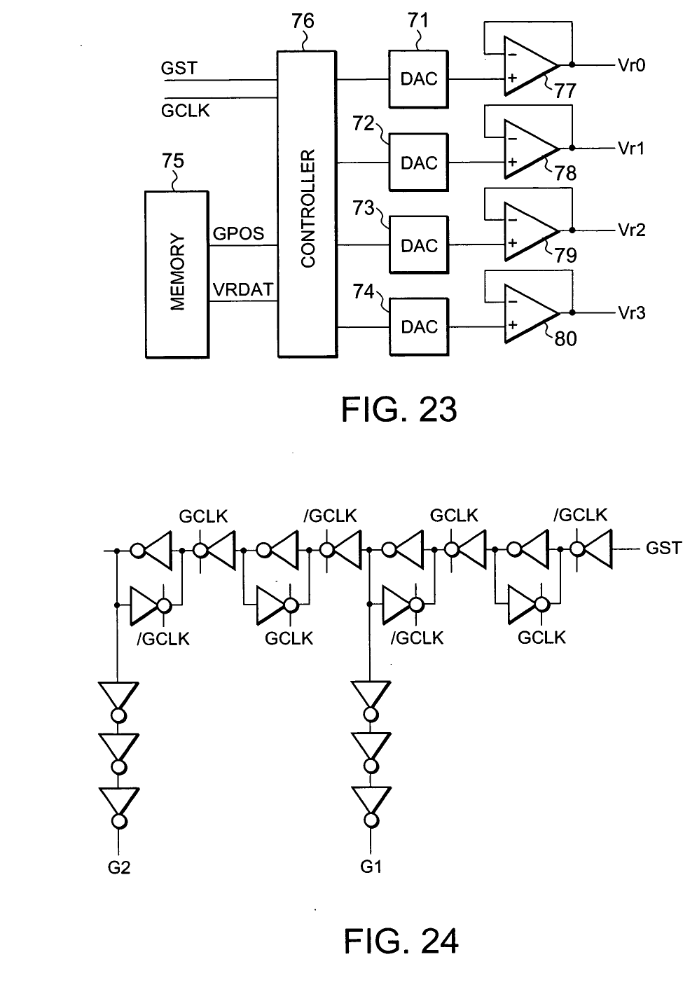

FIG. 23 shows an example of the reference voltage generation circuit 16. The reference voltage generation circuit 16 may externally be provided independently of the data line drive circuit shown in FIG. 9. Alternatively, the reference voltage generation circuit 16 may be incorporated into the data line drive circuit shown in FIG. 9. The reference voltage generation circuit is required to have functions to vary reference voltages depending upon pixels into which the data line drive circuit is writing signals in the liquid crystal display apparatus. The reference voltage generation circuit is also required to quickly stabilize outputs right before horizontal periods are switched. In the illustrated example, the reference voltage generation circuit 16 includes DACs 71 to 74, a memory 75 for holding data to be supplied to the DACs 71 to 74, a controller 76 for controlling the memory 75 and the DACs 71 to 74, and buffer circuits 77 to 80 for buffering outputs of the DACs 71 to 74. The controller 76 detects a pixel row into which video signals are being written in the liquid crystal display apparatus by using, for example, a clock signal for controlling a gate driver circuit, which drives gate lines in the liquid crystal display apparatus. In the example shown in FIG. 23, the controller 76 uses a control signal GST for the gate driver circuit and a clock signal GCLK. The memory 75 holds reference voltage data for each pixel row into which signals are to be written and outputs reference voltage data VRDAT corresponding to a signal GPOS outputted from the controller 76, which represents the current writing pixel row. The controller 76 outputs data from the memory 75 into the DACs 71 to 74. The data are converted into voltages by the DACs 71 to 74 and outputted through the buffer circuits 77 to 80 to the voltage division circuit 50.

FIG. 24 shows the gate driver circuit 53 provided in the liquid crystal display apparatus shown in FIG. 16. The gate driver circuit is required to have functions to sequentially output, into the gate lines, pulses that allow the pixel thin film transistors TFT to be in a conducted state for each horizontal period. Shift registers can suitably be used as the gate driver circuit. In the example shown in FIG. 24, the gate driver circuit 53 employs shift registers controlled by two clock signals GCLK and /GCLK and a start signal GST. The circuit shown in FIG. 24 includes two stages of shift registers (for the outputs G1 and G2). The number of stages of the shift registers is determined by the number of the gate lines in the liquid crystal display apparatus.

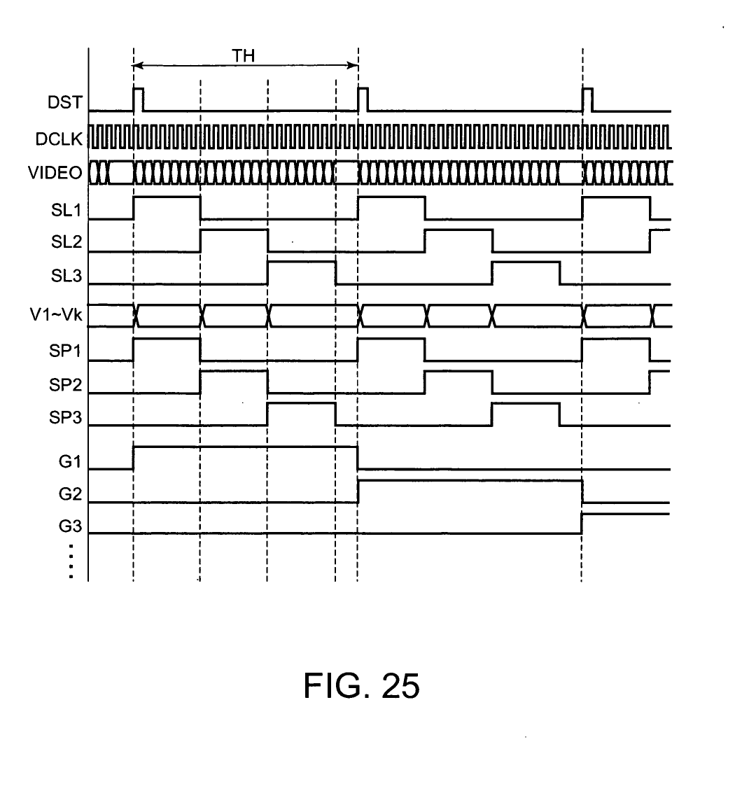

Next, operation will be described. FIG. 25 is a timing chart showing an operation of the data line drive circuit. A period TH represents a horizontal period during which signals are written into one pixel row in the liquid crystal display device. During the horizontal period, the line memory 20 in the data line drive circuit samples digitalized video signals VIDEO, which are supplied in synchronism with a clock signal DCLK, and holds the video signals VIDEO in the memories M1a to Mna. After video signals corresponding to one pixel row are sampled, the video signals held in the memories M1a to Mna are transferred all at once into the memories M1b to Mnb at the end of the horizontal period. Concurrently with the operation of sampling signals, video signals that already have been transferred into the memories M1b to Mnb are transferred to the decoders with time-sharing. The time-sharing is controlled by the control signals SL1 to SL3. During a period of time during which the control signal SL1 has a high level, contents of the memories that are connected to the switches 62, which are controlled by the control signal SL1, are transferred to the DACs, which include the decoders and the selectors. Similarly, during a period of time during which the control signal SL2 has a high level, contents of the memories that are connected to the switches 62, which are controlled by the control signal SL2, are transferred to the DACs. During a period of time during which the control signal SL3 has a high level, contents of the memories that are connected to the switches 62, which are controlled by the control signal SL3, are transferred to the DACs. Thus, the data held in the memories M1b to Mnb are transferred into the decoders by three operations. The DACs select one of voltages generated in the voltage division circuit according to the data and output it through the buffers. Synchronously, the switches in the liquid crystal display apparatus are controlled by the control signals SP1 to SP3, so that the signals outputted from the data line drive circuit are written into the data lines. In the example shown in FIG. 25, the control signal SP1 becomes high in synchronism with the control signal SL1 to write signals into the data lines D1, D4, D7, and the like. Similarly, the control signal SP2 becomes high in synchronism with the control signal SL2, and the control signal SP3 becomes high in synchronism with the control signal SL3. In this manner, the signals are written into all the data lines. When a pulse that allows a pixel thin film transistor TFT to be in a conducted state is written into one of the gate lines by the gate driver circuit, the video signals written into the data lines are written into the pixels and the storage capacitances through the pixel thin film transistors TFT. This operation is performed for all of the gate lines so as to write a screenful of video signals into the liquid crystal display apparatus.

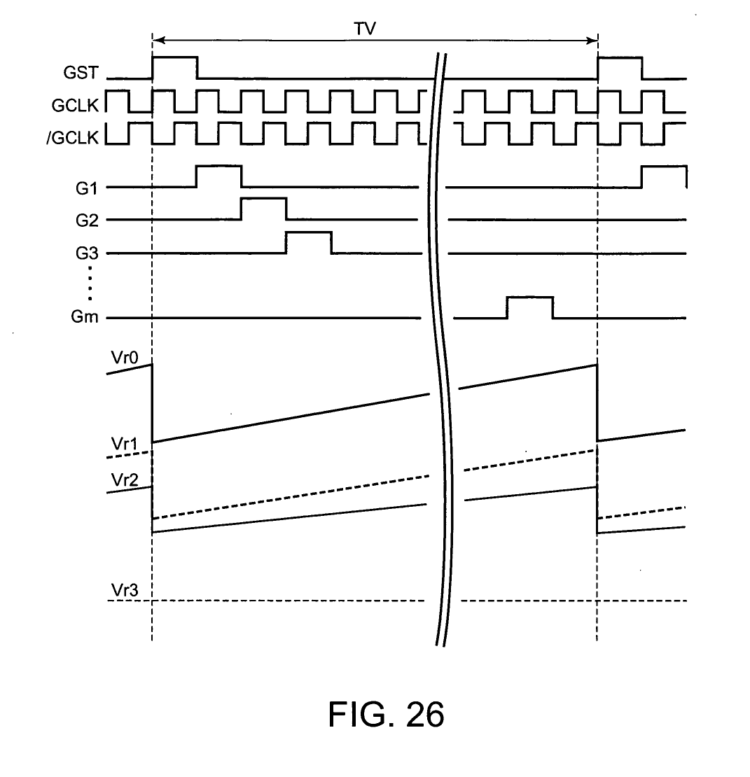

FIG. 26 is a timing chart showing an operation of the gate driver circuit and the reference voltage generation circuit. The gate driver circuit sequentially transfers pulses to next stages in synchronism with a clock signal GCLK when the start signal GST triggers the gate driver circuit. Since one period of the clock signal GCLK is equal to one horizontal period, the gate driver circuit outputs a pulse to the gate line sequentially at each horizontal period. The reference voltage generation circuit detects pixel row into which video signals are being written by counting pulses of the clock signal GCLK while the start signal GST is used as a trigger. The reference voltage data are read from the memories to vary the reference voltages Vr0 to Vr3 as shown in FIG. 26.

The voltage division circuit is supplied with a polarity reversal signal INV. When the liquid crystal display apparatus is to be driven by reversal drive of the gate lines, the polarity reversal signal INV is reversed at each horizontal period. When the liquid crystal display apparatus is to be driven by reversal drive of the frames, the polarity reversal signal INV is reversed at each vertical period.

When the liquid crystal display apparatus using the data line drive circuit in Example 1 is driven, it is possible to remarkably reduce luminance irregularities even if the V-T characteristics depend on positions in the liquid crystal display apparatus. In the data line drive circuit according to the present invention, the size of circuits can be reduced as described above.

### EXAMPLE 2

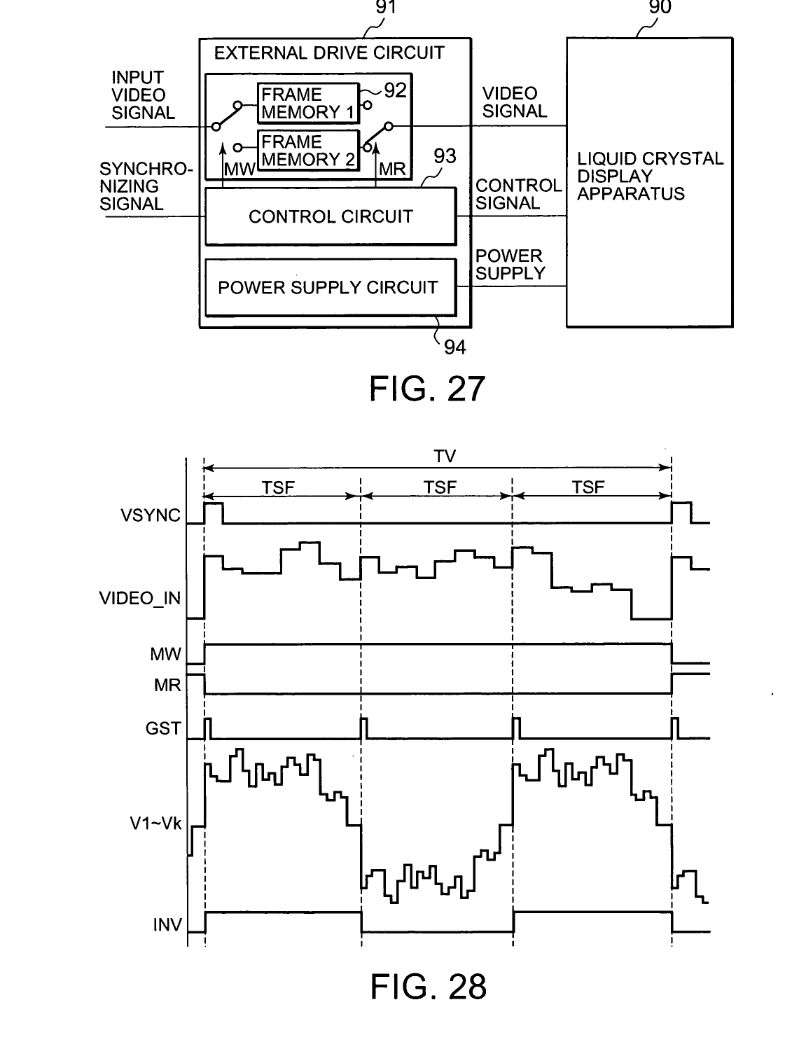

A second example of the present invention will be described below. FIG. 27 shows a system for driving a liquid crystal display apparatus using a data line drive circuit in the second example of the present invention. The system shown in FIG. 27 has a liquid crystal display apparatus 90 using a data line drive circuit according to the present invention and an external drive circuit 91. The external drive circuit 91 obtains input video signals and synchronizing signals from a signal source for supplying video signals. Then, the external drive circuit 91 outputs video signals and control signals to the liquid crystal display apparatus 90. At that time, the external drive circuit 91 also supplies voltages required for various power sources in the liquid crystal display apparatus 90. The external drive circuit 91 includes memories 92 capable of holding at least one screenful of video signals supplied from the signal source. In the illustrated example, the external drive circuit 91 includes two memories (frame memory 1 and frame memory 2) each for a screenful of data. The external drive circuit 91 also includes at least a control circuit 93 for producing signals MW and MR for controlling the memories 92 and a control signal for controlling the liquid crystal display apparatus 90. The external drive circuit 91 includes a power supply circuit 94 for producing voltages for various power sources. The liquid crystal display apparatus 90 has the same arrangement as that in Example 1.

Next, operation in the second example will be described. FIG. 28 is a timing chart showing an operation of the external drive circuit 91 shown in FIG. 27. A video signal VIDEO_IN is supplied from the signal source in synchronism with a synchronizing signal VSYNC. Memory control signals MW and MR determine one of the two memories 92 into which signals are written and one of the two memories 92 from which signals are read. Assuming that input video signals from the signal source are written into the frame memory 1 while signals are read from the frame memory 2 during a certain period of time, input video signals are to be written into the frame memory 2 while signals are to be read from the frame memory 1 during a next period of time. Such operation achieves frequency conversion in which input video signals supplied from the signal source are read at different frequencies. When a vertical period of input video signals supplied from the signal source is represented by TV, the start signal GST of the gate driver circuit includes three pulses in the vertical period TV. Specifically, a screenful of images are written into the liquid crystal display apparatus during one of three subframe periods TSF, into which the vertical period TV of the signal source is divided. Further, a polarity control signal INV, which controls polarities of the video signals to be written into the pixels in the liquid crystal display apparatus, is reversed at each subframe period. Signals V1 to Vk having the same polarity are written into all the pixels during the subframe period. In the example shown in FIG. 28, the vertical period is divided into three subframe periods. However, the vertical period may be divided into two or more subframe periods. Operation of the data line drive circuit and the liquid crystal display apparatus during the subframe is the same as the operation described in Example 1.

The liquid crystal display apparatus using the data line drive circuit in Example 2 can display an image having no luminance irregularities in a screen and a high contrast ratio for the following reasons.

A liquid crystal display apparatus used for a projector has a small panel because the apparatus is required to be compact. Liquid crystal display apparatuses having pixel pitches of 20 μm or less are mostly used. If pixels have such a level of size, it becomes difficult to fully cover disclination, which is disturbance of alignment in liquid crystal molecules, with black matrices. This is because an opening ratio of pixels is considerably lowered so as to reduce light passing through the pixels when black matrices have a large width. Frame inversion drive in which signals having the same polarity are written into adjacent pixels can be performed in order to prevent the disclination. However, the frame inversion drive problematically causes occurrence of flicker and production of luminance irregularities in a screen. In order to prevent flicker, it is effective to shorten a period during which the liquid crystal display apparatus rewrites a screenful of signals. According to the experiments, the flicker disappeared at a subframe frequency of 120 Hz.

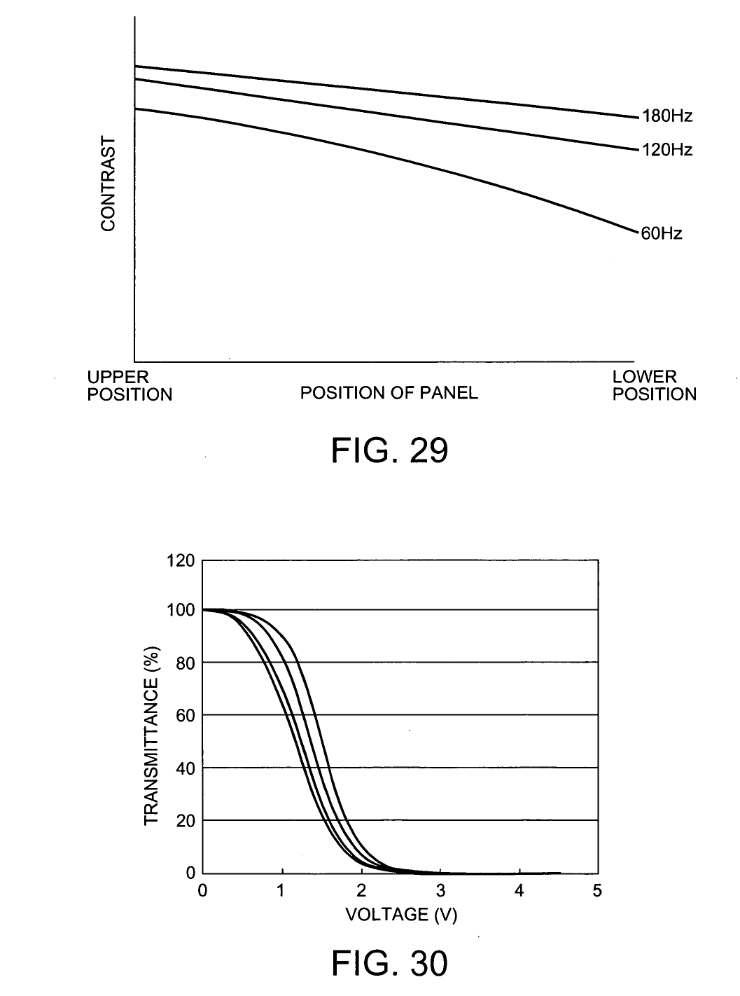

The luminance irregularities in the screen are caused by variation of a leak current of a pixel voltage. The leak current depends on a voltage between a source and a drain of a pixel thin film transistor TFT. As a potential difference between the source and the drain of the pixel thin film transistor TFT is larger, the amount of leak is larger. When the frame inversion drive is performed, a pixel voltage and a potential difference between data lines are small in a pixel into which a first signal is written in a frame. The potential difference becomes large in a pixel into which a last signal is written in the frame because a signal having an opposite polarity is to be written into a data line in the next frame. Thus, variations of pixel voltages due to a leak current differ between the pixel into which the first signal is written and the pixel into which the last signal is written in the same frame. This variation difference causes the luminance irregularities. This phenomenon can be reduced when the subframe frequency is increased to shorten leaking time. According to the experiments, as shown in FIG. 29, even if the liquid crystal display apparatus was driven at 180 Hz, contrast ratios differed between an upper portion of a panel, into which a first signal was written, and a lower portion of the panel, into which a last signal was written. The results of 60 Hz and the results of 120 Hz greatly differed from each other. However, the results of 180 Hz did not differ from the results of 120 Hz to a large extent. Thus, the aforementioned two problems can be resolved by rewriting images at a frequency higher than two time of 60 Hz in the liquid crystal display apparatus and correcting luminance differences in the panel with video signals.

FIG. 30 is a graph showing V-T characteristics measured at four points along a vertical direction of a panel when a frame inversion drive was performed at 120 Hz. As is apparent from FIG. 30, luminance irregularities in a screen could be regarded as positional dependency of the V-T characteristics. By varying V-T characteristics in the same manner as described in Example 1 according to positions in the panel, it was possible to reduce the luminance irregularities. Thus, when the liquid crystal display apparatus is driven by using a data line drive circuit according to the present invention, it is possible to display an image having no luminance irregularities in the screen and a high contrast ratio.

### EXAMPLE 3

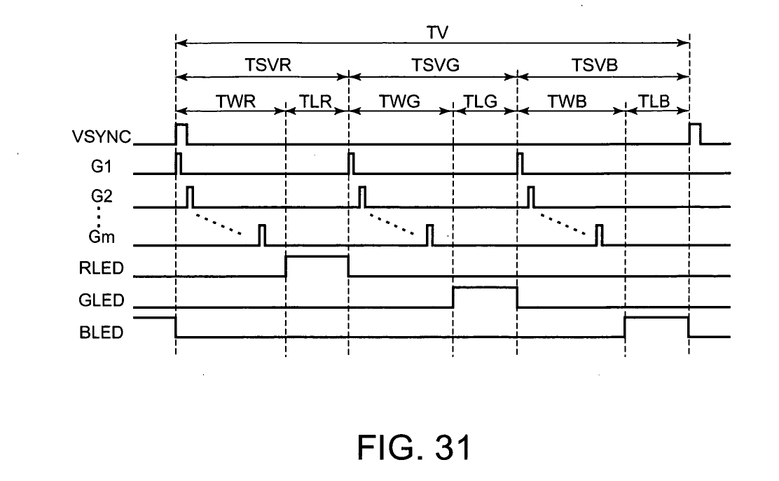

A third example of a liquid crystal display apparatus using a data line drive circuit according to the present invention will be described below. FIG. 31 is a timing chart showing an operation of a liquid crystal display apparatus using a data line drive circuit according to the present invention. The data line drive circuit and the liquid crystal display apparatus have the same arrangements as those in Examples 1 and 2, and will not be described below repetitively. A period TV represents a period during which a screenful of video signals are supplied into the liquid crystal display apparatus from the exterior of the apparatus. In the liquid crystal display apparatus of Example 3, the period TV is divided into at least three subframe periods (TSVR, TSVG, and TSVB). Each of the subframe periods is also divided into at least two periods (TWR and TLR, TWG and TLG, and TWB and TLB, respectively). Signals of red components in video signals are written during the period TWR. During the period TLR, red light is applied to the liquid crystal display apparatus by a signal RLED. Similarly, signals of green components in the video signals are written during the period TWG. During the period TLG, green light is applied to the liquid crystal display apparatus by a signal GLED. Signals of blue components in the video signals are written during the period TWB. During the period TLB, blue light is applied to the liquid crystal display apparatus by a signal BLED. Field sequential drive employs this operation to display colored images without color filters provided in a liquid crystal display apparatus. Operations during the respective subframe periods are the same as those in Example 1.

According to a liquid crystal display apparatus using a data line drive circuit of the present invention, it is possible to remarkably reduce luminance irregularities in a screen for the following reasons. With the field sequential drive, a period of time from the time when a signal is written to the time when a light source is lighted differs between a pixel into which a first signal is written in a subframe and a pixel into which a last signal is written in the subframe. If a speed of response of liquid crystal molecules is much lower than a subframe period, then no problem arises. However, if a speed of response is equal to or higher than a subframe period, then liquid crystal molecules have different orientations at the beginning of lighting of the light source even if the same signals are written. Different orientations of the liquid crystal molecules produce a difference of the transmittance of the pixels, thereby causing luminance irregularities in a screen. However, the luminance variations can be regarded as variations of V-T characteristics in the panel. Therefore, when a liquid crystal display apparatus is driven by using a data line drive circuit according to the present invention, it is possible to reduce luminance irregularities in a screen.

Examples of a liquid crystal display apparatus according to the present invention include front-type liquid crystal projectors, rear-type liquid crystal projectors, and personal digital assistants.

Although certain preferred embodiments of the present invention have been shown and described in detail, it should be understood that various changes and modifications may be made therein without departing from the scope of the appended claims.

What is claimed is:

1. A data line drive circuit for driving pixels via data lines in a liquid crystal display apparatus, the data line drive circuit comprising:
digital-to-analog converter circuits operable to output drive signals from input digital video signals into the data lines, input-output characteristics of the digital-to-analog converter circuits being dynamically varied during a period of time during which a screenful of video signals are written into the pixels in the liquid crystal display apparatus.

2. The data line drive circuit according to claim 1, wherein the input-output characteristics of the digital-to-analog converters are varied at each period during which video signals are written into one pixel row.

3. The data line drive circuit according to claim 1, wherein the input-output characteristics of the digital-to-analog converters are nonlinear.

4. The data line drive circuit according to claim 1, wherein the data line drive circuit is a semiconductor circuit connected on a transparent substrate forming the liquid crystal display apparatus.

5. A data line drive circuit for driving pixels via data lines in a liquid crystal display apparatus, the data line drive circuit comprising:
a reference voltage generation circuit operable to generate a plurality of reference voltages;
a voltage division circuit operable to divide the plurality of reference voltages into division voltages, a number of the division voltages being greater than a number of the reference voltages; and
digital-to-analog converter circuits operable to select one of the division voltages generated in the voltage division circuit based on an input digital video signal and to output the one of the division voltages as a drive signal into the data lines, the reference voltages being varied during a vertical period, during which a screenful of video signals are written into the pixels in the liquid crystal display apparatus, to vary input-output characteristics of the digital-to-analog converter circuits.

6. The data line drive circuit according to claim 5, wherein the reference voltage generation circuit includes:
a memory operable to store information indicative of a position in a screen of the liquid crystal display apparatus and information indicative of selection of the reference voltages at the position; and
an output circuit operable to read and output the reference voltages at a position corresponding to a scanning signal of the screen from the memory.

7. The data line drive circuit according to claim 5, wherein each of the digital-to-analog converter circuits includes:
a decoder operable to decode the digital video signals; and
a selector operable to select one of the reference voltages supplied from the voltage division circuit based on an output of the decoder and to output the one of the reference voltages as an analog signal.

8. The data line drive circuit according to claim 5, wherein the data line drive circuit is a semiconductor circuit connected on a transparent substrate forming the liquid crystal display apparatus.

9. A liquid crystal display apparatus comprising:
data lines;
pixels into which video signals are written via the data lines, the video signals being written into all of the pixels so as to have a same polarity with respect to a potential of a counter electrode during a period during which a screenful of video signals are displayed in the liquid crystal display apparatus; and
a data line drive circuit for driving the pixels via the data lines, the data line drive circuit including digital-to-analog converter circuits operable to output drive signals from input digital video signals into the data lines, input-output characteristics of the digital-to-analog converter circuits being dynamically varied during a period of time during which a screenful of video signals are written into said pixels in the liquid crystal display apparatus.

10. The liquid crystal display apparatus according to claim 9, wherein the liquid crystal display apparatus is configured to display a screenful of video signals at a frequency of at least 120 Hz.

11. A liquid crystal display apparatus comprising:
data lines;
pixels into which video signals are written via the data lines, the video signals being written into all of the pixels so as to have a same polarity with respect to a potential of a counter electrode during a period during which a screenful of video signals are displayed in the liquid crystal display apparatus; and
a data line drive circuit for driving the pixels via said data lines, the data line drive circuit including:
(i) a reference voltage generation circuit operable to generate a plurality of reference voltages;
(ii) a voltage division circuit operable to divide the plurality of reference voltages into division voltages, a number of the division voltages being greater than a number of the reference voltages; and
(iii) digital-to-analog converter circuits operable to select one of the division voltages generated in the voltage division circuit based on an input digital video signal and to output the one of the division voltages as a drive signal into said data lines, the reference voltages being varied during a vertical period, during which a screenful of video signals are written into the pixels, to vary input-output characteristics of the digital-to-analog converter circuits.

12. The liquid crystal display apparatus according to claim 11, wherein the liquid crystal display apparatus is configured to display a screenful of video signals at a frequency of at least 120 Hz.

13. A projector apparatus comprising:
a liquid crystal display device including:
(i) data lines;
(ii) pixels into which video signals are written via the data lines; and
(iii) a data line drive circuit for driving the pixels via the data lines, the data line drive circuit including digital-to-analog converter circuits operable to output drive signals from input digital video signals into the data lines, input-output characteristics of the digital-to-analog converter circuits being dynamically varied during a period of time during which a screenful of video signals are written into the pixels in the liquid crystal display apparatus.

14. A projector apparatus comprising:
a liquid crystal display device including:
(i) data lines;
(ii) pixels into which video signals are written via the data lines; and
(iii) a data line drive circuit for driving the pixels via the data lines, the data line drive circuit including:
(a) a reference voltage generation circuit operable to generate a plurality of reference voltages;
(b) a voltage division circuit operable to divide the plurality of reference voltages into division voltages, a number of the division voltages being greater than a number of the reference voltages; and
(c) digital-to-analog converter circuits operable to select one of the division voltages generated in the voltage division circuit based on an input digital video signal and to output the one of the division voltages as a drive signal into the data lines, the reference voltages being varied during a vertical period, during which a screenful of video signals are written into the pixels, to vary input-output characteristics of the digital-to-analog converter circuits.

15. A liquid crystal display apparatus comprising:
data lines;
pixels into which video signals are written via the data lines;
a data line drive circuit for driving the pixels via said data lines, the data line drive circuit including digital-to-analog converter circuits operable to output drive signals from input digital video signals into the data lines, input-output characteristics of said digital-to-analog converter circuits being dynamically varied during a period of time during which a screenful of video signals are written into said pixels in the liquid crystal display apparatus;
a first substrate on which the pixels are formed; and
a second substrate formed so as to face the first substrate,
wherein no color filters are provided on the first substrate or the second substrate, and light having different wavelength ranges is applied in synchronism with a cycle in which a screenful of video signals are written.

16. A liquid crystal display apparatus comprising:
data lines;
pixels into which video signals are written via the data lines;
a data line drive circuit for driving the pixels via the data lines, the data line drive circuit including:
(i) a reference voltage generation circuit operable to generate a plurality of reference voltages;
(ii) a voltage division circuit operable to divide the plurality of reference voltages into division voltages, a number of the division voltages being greater than a number of the reference voltages; and
(iii) digital-to-analog converter circuits operable to select one of the division voltages generated in the voltage division circuit based on an input digital video signal and to output the one of the division voltages as a drive signal into the data lines, the reference voltages being varied during a vertical period, during which a screenful of video signals are written into said pixels, to vary input-output characteristics of the digital-to-analog converter circuits;
a first substrate on which the pixels are formed; and
a second substrate formed so as to face the first substrate,
wherein no color filters are provided on the first substrate or the second substrate, and light having different wavelength ranges is applied in synchronism with a cycle in which a screenful of video signals are written.

17. A terminal apparatus comprising:
a liquid crystal display device including:
(i) data lines;
(ii) pixels into which video signals are written via the data lines; and
(iii) a data line drive circuit for driving the pixels via the data lines, the data line drive circuit including digital-to-analog converter circuits operable to output drive signals from input digital video signals into the data lines, input-output characteristics of the digital-to-analog converter circuits being dynamically varied during a period of time during which a screenful of video signals are written into the pixels in the liquid crystal display apparatus.

18. A projector apparatus comprising:
a liquid crystal display device including:
(i) data lines;
(ii) pixels into which video signals are written via the data lines; and
(iii) a data line drive circuit for driving the pixels via the data lines, the data line drive circuit including:
(a) a reference voltage generation circuit operable to generate a plurality of reference voltages;
(b) a voltage division circuit operable to divide the plurality of reference voltages into division voltages, a number of the division voltages being greater than a number of the reference voltages; and
(c) digital-to-analog converter circuits operable to select one of the division voltages generated in the voltage division circuit based on an input digital video signal and to output the one of the division voltages as a drive signal into said data lines, the reference voltages being varied during a vertical period, during which a screenful of video signals are written into the pixels, to vary input-output characteristics of the digital-to-analog converter circuits.

19. A method of driving pixels via data lines in a liquid crystal display apparatus to display an image in the liquid crystal display apparatus, the method comprising:
outputting drive signals from input digital video signals into the data lines by digital-to-analog conversion;
dynamically varying input-output characteristics of the digital-to-analog conversion during a period of time during which a screenful of video signals are written into the pixels in the liquid crystal display apparatus.

20. The method according to claim 19, wherein the dynamically varying input-output characteristics of the digital-to-analog conversion comprises varying the input-output characteristics of the digital-to-analog conversion at each period during which video signals are written into one pixel row.

21. The method according to claim 19, wherein the input-output characteristics of the digital-to-analog conversion are nonlinear.

22. The method according to claim 19, further comprising displaying a screenful of video signals at a frequency of at least 120 Hz.

23. The method according to claim 19, wherein the liquid crystal display apparatus includes no color filters on a first substrate on which the pixels are formed or a second substrate formed so as to face the first substrate,
wherein light having different wavelength ranges is applied in synchronism with a cycle in which a screenful of video signals are written.
